(19) United States
(12) Patent Application Publication
(10) Pub. No.: US 2016/0078013 A1
(43) Pub. Date: Mar. 17, 2016

(54) FAULT-TOLERANT INPUT METHOD EDITOR

(71) Applicants: Baohua LIAO, Beijing (CN); Albert J. WONG, Seattle, WA (US); Hannah C. TANG, Seattle, WA (US); Fan YANG, Haidian District, Beijing (CN); Henry OU, Haidian District, Beijing (CN); Yuanbo ZHANG, Haidian District, Beijing (CN)

(72) Inventors: Baohua Liao, Beijing (CN); Albert J. Wong, Seattle, WA (US); Hannah C. Tang, Seattle, WA (US); Fan Yang, Beijing (CN); Henry Ou, Beijing (CN); Yuanbo Zhang, Beijing (CN)

(73) Assignee: GOOGLE INC., Mountain View, CA (US)

(21) Appl. No.: 14/787,082

(22) PCT Filed: Apr. 27, 2013
(86) PCT No.: PCT/CN2013/074901

§ 371 Date: Oct. 26, 2015

(51) Int. Cl. G06F 17/24; G06N 5/04; G06F 3/01

(52) U.S. Cl. CPC G06F 17/24; G06F 3/018; G06N 5/048

(57) ABSTRACT

A computer-implemented method can include receiving, at a computing device including one or more processors, an input from a user. The input can include one or more characters in a first writing system. The method can further include segmenting the input to obtain one or more segmentations, where each segmentation can include at least one segment including at least one character in the first writing system. A fuzzy model can be applied to the segmentations to obtain potential formal representations for the segmentations. Each of the potential formal representations can be in the first writing system and represent text in a second writing system. A plurality of character candidates can be determined based on the potential formal representations. Each of the plurality of character candidates can be a possible appropriate representation of the user input in the second writing system.

### FIELD

The present disclosure is generally directed to an improved Input Method Editor, and more specifically, to an Input Method Editor that permits a user to input characters in a writing system for which there is no widely-known and adopted representation standard for in another writing system.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An Input Method Editor (“IME”) can be utilized to convert an input in a first writing system (e.g., Pinyin) to an output in a second writing system (e.g., Hanzi). In this manner, a user can obtain text in the second writing system through the use of a keyboard representing characters in the first writing system. For some languages/writing systems, however, there may be no single widely-known and adopted representation standard for inputting text in a first writing system to obtain text in a second writing system. Thus, a user that is unfamiliar with the specific representation standard implemented by the IME may be unable to efficiently utilize its capabilities until she/he learns the implemented representation standard, which may be difficult and time-consuming for a user.

### SUMMARY

According to various implementations of the present disclosure, a computer-implemented method is disclosed. The method can include receiving, at a computing device including one or more processors, an input from a user. The input can include one or more characters in a first writing system. The method can further include segmenting the input to obtain one or more segmentations. Each segmentation can include at least one segment, and each segment can include at least one character in the first writing system. Additionally, the method can include applying a fuzzy model to the one or more segmentations to obtain at least one potential formal representation for each of the segmentations. Each of the potential formal representations can be in the first writing system and represent text in a second writing system. A plurality of character candidates can be determined based on the potential formal representations. Each of the plurality of character candidates can be in the second writing system and be a possible appropriate representation of the user input in the second writing system. Also, the method can include outputting the plurality of character candidates.

In some embodiments, applying the fuzzy model to the one or more segmentations can include obtaining a probability for each specific potential formal representation, where the probability represents a likelihood that the specific potential formal representation corresponds to the input.

Further, outputting the plurality of character candidates can include displaying a set of the plurality of character candidates in a ranked order on a display of the computing device. The ranked order can be based on a likelihood that each character candidate of the set of the plurality of character candidates corresponds to the input. Additionally or alternatively, each particular character candidate of the set of the plurality of character candidates can be associated with a particular potential formal representation, and the likelihood for each particular character candidate can be based on: (i) a first probability that the particular potential formal representation corresponds to the input, and (ii) a second probability that the particular potential formal representation corresponds to the particular character candidate.

In various embodiments, the method can further include receiving a user selection of one of the set of the plurality of character candidates, and displaying on the display the selected one in a text entry area. Additionally or alternatively, displaying the set of the plurality of character candidates on the display of the computing device can further include displaying each particular character candidate with its associated particular potential formal representation.

According to some implementations, each particular character candidate of the plurality of character candidates can be associated with a particular potential formal representation, and outputting the plurality of character candidates can include displaying, on a display of the computing device, at least one specific character candidate of the plurality of character candidates and its associated potential formal representation. Further, the first writing system can be a Latin alphabet writing system, the second writing system can be a non-Latin alphabet writing system, and the formal representation can be a formal Romanization. In some implementations, the second writing system can be written Cantonese and/or each potential formal representation can be a Yale representation.

According to further implementations of the present disclosure, a computing device is disclosed. The computing device can include a display, one or more processors coupled to the display, and a non-transitory computer-readable storage medium storing executable computer program code. The one or more processors configured to execute the executable computer program code to perform operations.

The operations can include receiving an input from a user. The input can include one or more characters in a first writing system. The operations can further include segmenting the input to obtain one or more segmentations. Each segmentation can include at least one segment, and each segment can include at least one character in the first writing system. Additionally, the operations can include applying a fuzzy model to the one or more segmentations to obtain at least one potential formal representation for each of the segmentations. Each of the potential formal representations can be in the first writing system and represent text in a second writing system. A plurality of character candidates can be determined based on the potential formal representations. Each of the plurality of character candidates can be in the second writing system and be a possible appropriate representation of the user input in the second writing system. Also, the operations can include outputting the plurality of character candidates.

In some embodiments, applying the fuzzy model to the one or more segmentations can include obtaining a probability for each specific potential formal representation, where the probability represents a likelihood that the specific potential formal representation corresponds to the input.

Further, outputting the plurality of character candidates can include displaying a set of the plurality of character candidates in a ranked order on the display of the computing device. The ranked order can be based on a likelihood that each character candidate of the set of the plurality of character candidates corresponds to the input. Additionally or alternatively, each particular character candidate of the set of the plurality of character candidates can be associated with a particular potential formal representation, and the likelihood for each particular character candidate can be based on: (i) a first probability that the particular potential formal representation corresponds to the input, and (ii) a second probability that the particular potential formal representation corresponds to the particular character candidate.

In various embodiments, the operations can further include receiving a user selection of one of the set of the plurality of character candidates, and displaying on the display the selected one in a text entry area. Additionally or alternatively, displaying the set of the plurality of character candidates on the display of the computing device can further include displaying each particular character candidate with its associated particular potential formal representation.

According to some implementations, each particular character candidate of the plurality of character candidates can be associated with a particular potential formal representation, and outputting the plurality of character candidates can include displaying, on the display of the computing device, at least one specific character candidate of the plurality of character candidates and its associated potential formal representation. Further, the first writing system can be a Latin alphabet writing system, the second writing system can be a non-Latin alphabet writing system, and the formal representation can be a formal Romanization. In some implementations, the second writing system can be written Cantonese and/or each potential formal representation can be a Yale representation.

According to various implementations of the present disclosure, a non-transitory computer-readable storage medium storing computer executable code is disclosed. The computer executable code, when executed by a computing device having one or more processors, can cause the computing device to perform operations.

The operations can include receiving an input from a user. The input can include one or more characters in a first writing system. The operations can further include segmenting the input to obtain one or more segmentations. Each segmentation can include at least one segment, and each segment can include at least one character in the first writing system. Additionally, the operations can include applying a fuzzy model to the one or more segmentations to obtain at least one potential formal representation for each of the segmentations. Each of the potential formal representations can be in the first writing system and represent text in a second writing system. A plurality of character candidates can be determined based on the potential formal representations. Each of the plurality of character candidates can be in the second writing system and be a possible appropriate representation of the user input in the second writing system. Also, the operations can include outputting the plurality of character candidates.

In some embodiments, applying the fuzzy model to the one or more segmentations can include obtaining a probability for each specific potential formal representation, where the probability represents a likelihood that the specific potential formal representation corresponds to the input.

Further, outputting the plurality of character candidates can include displaying a set of the plurality of character candidates in a ranked order on the display of the computing device. The ranked order can be based on a likelihood that each character candidate of the set of the plurality of character candidates corresponds to the input. Additionally or alternatively, each particular character candidate of the set of the plurality of character candidates can be associated with a particular potential formal representation, and the likelihood for each particular character candidate can be based on: (i) a first probability that the particular potential formal representation corresponds to the input, and (ii) a second probability that the particular potential formal representation corresponds to the particular character candidate.

In various embodiments, the operations can further include receiving a user selection of one of the set of the plurality of character candidates, and displaying on the display the selected one in a text entry area. Additionally or alternatively, displaying the set of the plurality of character candidates on the display of the computing device can further include displaying each particular character candidate with its associated particular potential formal representation.

According to some implementations, each particular character candidate of the plurality of character candidates can be associated with a particular potential formal representation, and outputting the plurality of character candidates can include displaying, on the display of the computing device, at least one specific character candidate of the plurality of character candidates and its associated potential formal representation. Further, the first writing system can be a Latin alphabet writing system, the second writing system can be a non-Latin alphabet writing system, and the formal representation can be a formal Romanization. In some implementations, the second writing system can be written Cantonese and/or each potential formal representation can be a Yale representation.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an example computing device according to some implementations of the present disclosure;

FIG. 2 is a functional block diagram of the example computing device of FIG. 1;

FIG. 3 is a functional block diagram of the processor of the example computing device of FIGS. 1 and 2;

FIG. 4 is a diagram representing an example user input with its corresponding segmentations, potential formal representations, and character candidates according to some implementations of the present disclosure;

FIG. 5 is a schematic representation of an example display according to some implementations of the present disclosure;

FIGS. 6A-6C are schematic representations of example displays according to some implementations of the present disclosure; and

FIG. 7 is a flowchart describing an example technique for converting text in a first writing system to text in a second writing system according to some embodiments of the present disclosure.

### DETAILED DESCRIPTION

The present disclosure is directed to an improved Input Method Editor that permits a user to input characters in a writing system for which there is no widely-known and adopted representation standard. For some writing systems, there is a widely-known and adopted representation standard for representing characters with characters of a different writing system. For example, Pinyin is a widely-known representation standard for representing Hanzi characters of Mandarin Chinese with characters from a Roman or Latin alphabet. An Input Method Editor can be utilized to convert an input in a first writing system (e.g., Pinyin) to an output in a second writing system (e.g., Hanzi). In this manner, a user can obtain text in the second writing system through the use of a keyboard representing characters in the first writing system.

For some languages/writing systems, however, there may be no single widely-known and adopted representation standard. For example only, there are a number of representation standards (Yale, Jyutping, etc.) utilizing characters from the Latin alphabet to represent Cantonese in traditional or simplified Chinese characters. Each of these standards differs from one another, and many Cantonese-speaking users may be unfamiliar with one or all of these standards. Thus, many Cantonese-speaking users may be unable to efficiently utilize an Input Method Editor based on one or more of these standards.

The present disclosure provides for a system and method of providing an improved Input Method Editor (“IME”). The IME can be fault-tolerant to permit a user that is only somewhat familiar with a representation standard to utilize and efficiently input characters in a first writing system utilizing a user interface (e.g., keyboard) in a second writing system. For example only, the IME can permit a user to input Cantonese in traditional or simplified Chinese characters through the use of a Latin alphabet keyboard. Furthermore, the IME can provide feedback to the user such that the user can learn one or more formal representation standards through the use of the IME.

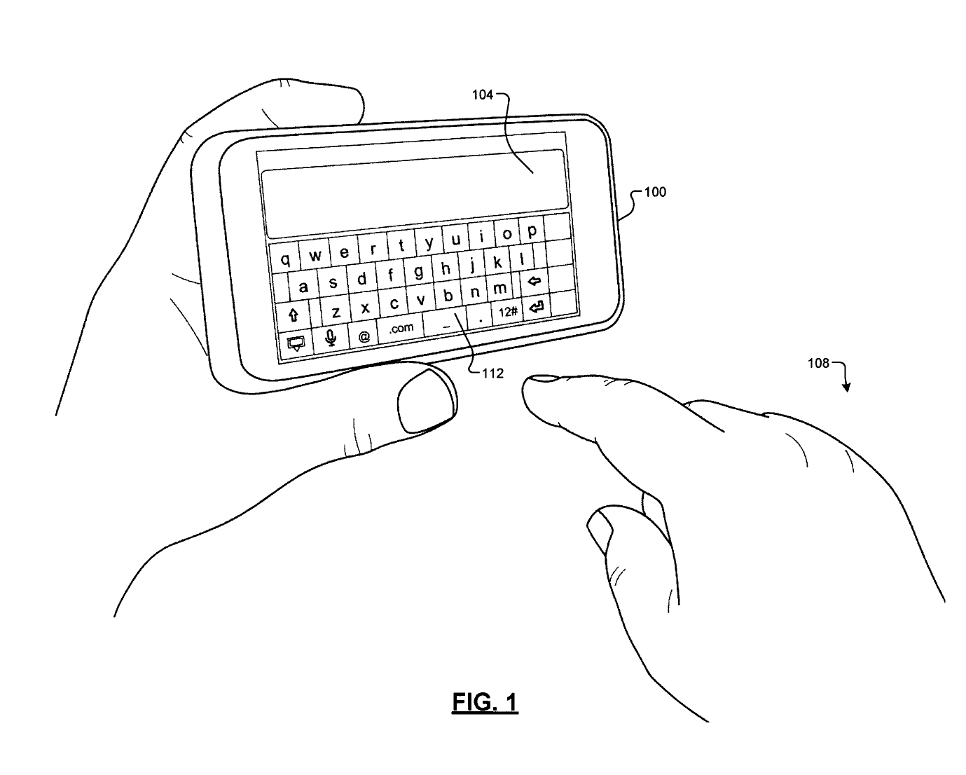

Referring now to FIG. 1, an example of a computing device 100 is shown. The computing device 100 is illustrated as a mobile phone, but it should be appreciated that the computing device 100 can be any type of computing device, e.g., a mobile phone, a tablet computer, a desktop computer, a laptop computer or a server computer. The computing device generally includes a user interface 104. The user interface 104 provides the mechanism by which a user 108 can interact with (provide input to, receive output from, etc.) the computing device 100. In the illustrated example, the user interface 104 is a touch display that displays information and receives input from a user 108. Although the user interface 104 is shown as a touch display that provides a virtual keyboard 112, the user interface 104 can include a traditional keyboard in addition to, or as an alternative to, the virtual keyboard. In some embodiments, the user interface 104 can also include a display, a physical keyboard, a microphone, one or more speakers, a computer mouse or other pointing device, and/or any other physical component through which the user 108 interacts with the computing device 100.

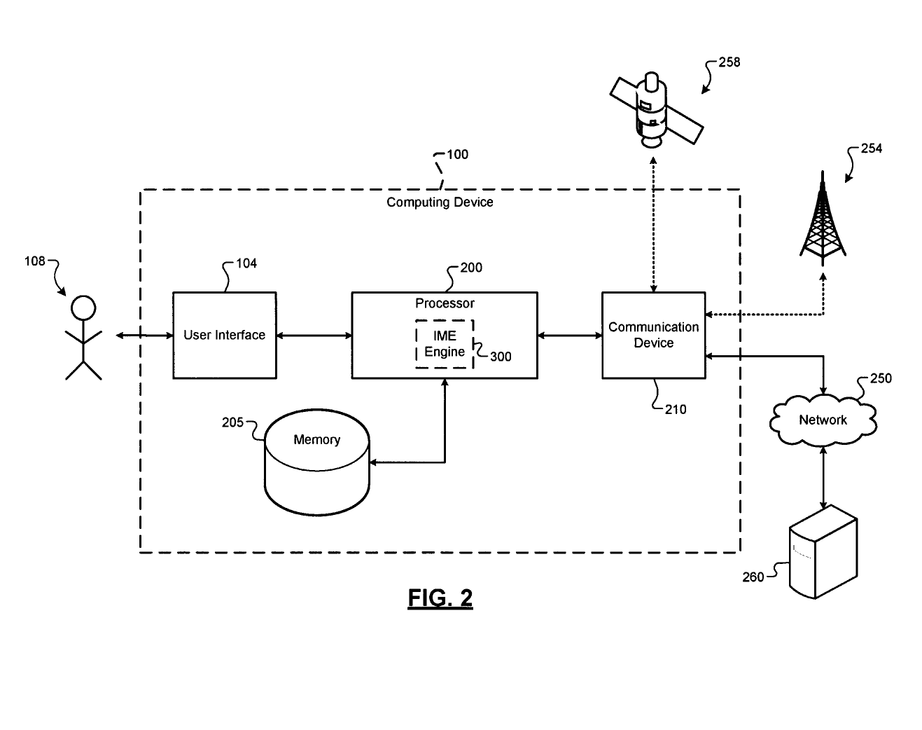

Referring now to FIG. 2, a functional block diagram of the example computing device 100 is illustrated. In addition to the user interface 104, the computing device 100 can further include a processor 200, a memory 205, and a communication device 210. It should be appreciated that the computing device 100 may include additional or fewer computing components than those illustrated. Furthermore, while the present disclosure describes a singular computing device 100, the term “computing device” as used herein is meant to include both a single computing device as well as a plurality of computing devices working in conjunction to perform the described techniques. For example only, the present disclosure may be implemented such that a computing device 100 operates in conjunction with a server computing device 260 (via the network 250) to perform the described techniques, where each of the computing device 100 and server computing device 260 perform a portion of the described techniques.

The processor 200 can control operation of the computing device 100. Specifically, the processor 200 can perform functions including, but not limited to loading/executing an operating system of the computing device 100, controlling communication with other components on the network 250 via the communication device 210, and controlling read/write operations at the memory 205. It should be appreciated that the term “processor” as used herein can refer to both a single processor and two or more processors operating in a parallel or distributed architecture. The processor 200 can also be configured to wholly or partially execute the techniques of the present disclosure, which are more fully described below.

The memory 205 can be any suitable storage medium (flash, hard disk, etc.) configured to store information at the computing device 100. For example only, the memory 205 can be a non-transitory computer-readable storage medium that stores executable computer program code. The processor 200 can be configured to execute the computer program code stored in the memory 205. In this manner, the computing device 100 can perform the operations of the techniques described below.

The communication device 210 can control communication between the computing device 100 and other devices. The communication device 210 can include any suitable components (e.g., a transceiver) configured for communication with other devices via a computing network 250 (e.g., the Internet), a mobile telephone network 254, and/or a satellite network 258. Other communication mediums may also be implemented. For example, the communication device 210 may configured for both wired and wireless network connections, e.g., radio frequency (RF) communication.

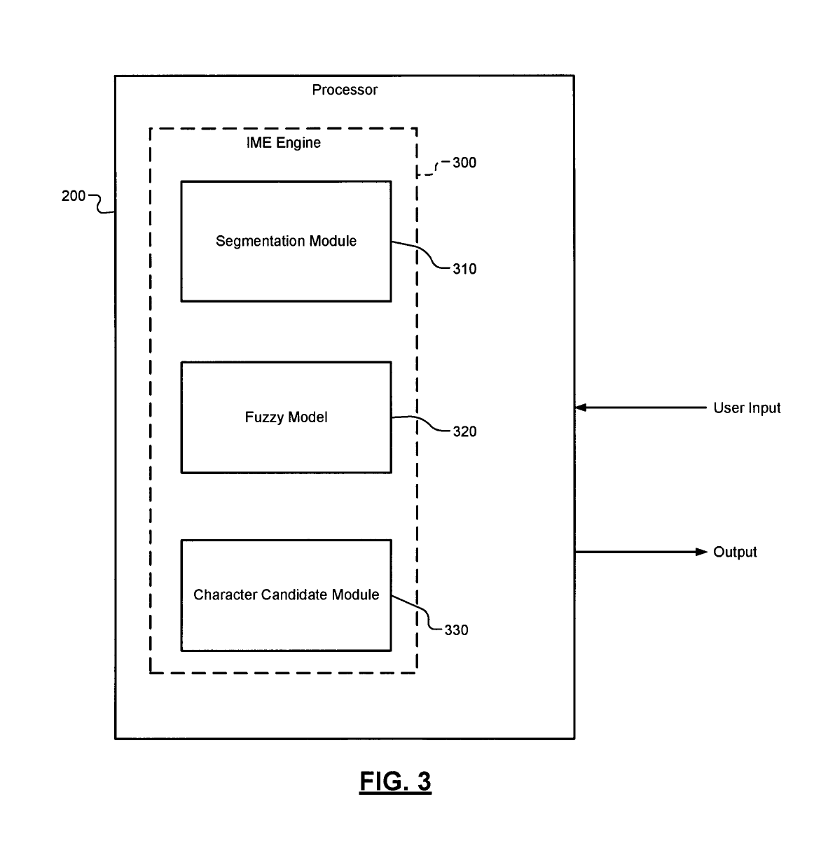

As illustrated in FIGS. 2 and 3, the processor 200 can execute and implement an IME Engine 300. The IME Engine 300 can include a segmentation module 310, a fuzzy model 320 and a character candidate module 330. The processor 200 and IME Engine 300 can receive user input and provide an output in response thereto. For example only, and in accordance with various implementations of the present disclosure, the processor 200 and IME Engine 300 can receive a user input in the form of one or more characters in a first writing system and output one or more characters in a second writing system corresponding to the user input. The detailed operation of each of these elements is described more fully below.

The user 108 may wish to input text to the computing device 100 in a writing system different from the writing system represented by the virtual keyboard 112. Through the use of the IME Engine 300, for example, the computing device 100 can convert input text in a first writing system associated with the virtual keyboard 112 or other input device to text in a second writing system.

The computing device (e.g., the IME Engine 300) can receive input from the user 108, for example, in the form of one or more characters in a first writing system presented by the user interface 104. The user 108 can provide an input to the computing device 100, e.g., by typing on the virtual keyboard 112. The virtual keyboard 112 is illustrated as a Latin alphabet keyboard, although a keyboard in any other writing system (Cyrillic, Arabic, etc.) could be utilized.

For writing systems that have a widely-known and accepted representation standard (such as the Pinyin representation standard for Hanzi characters of Mandarin Chinese), the user 108 can input the first writing system text (Pinyin) that corresponds to the second writing system text (Hanzi) desired by the user 108. For some writing systems/languages, however, there may be no single widely-known and accepted standard, and/or the user 108 may be unfamiliar with one or more particular representation standards. Thus, the user input can correspond to an attempt by the user 108 to input the formal representation (in the first writing system) for the desired text in the second writing system. Such a “fuzzy” input, however, may not correspond to the appropriate (or any) second writing system text in a typical IME environment. The present disclosure provides for a fault-tolerant IME that permits a user 108 that is unfamiliar with formal representation standards to input text in a second writing system via input in a first writing system.

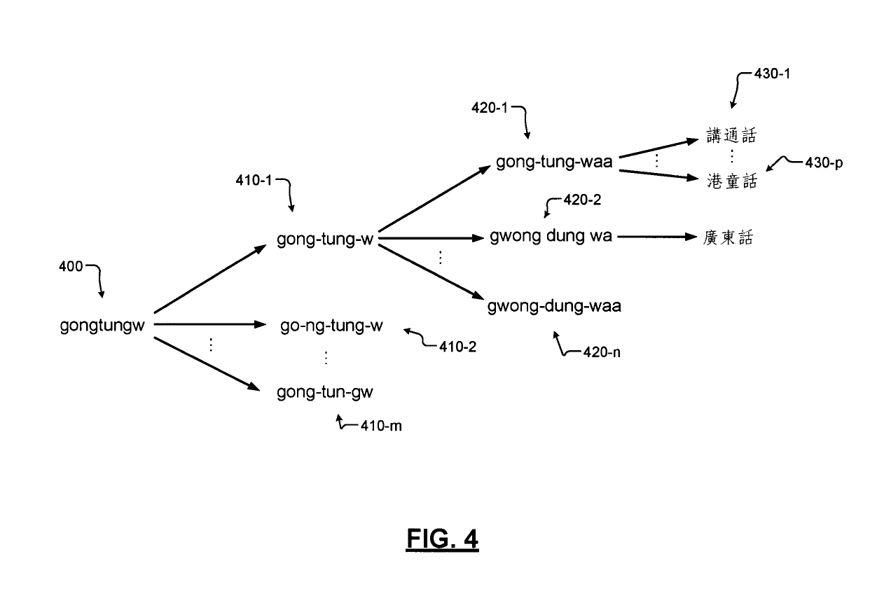

The processor 200 and the IME Engine 300 can receive the user input, e.g., from the user interface 104. The segmentation module 310 can determine the various ways of segmenting the user input to obtain one or more segmentations. Each of the segmentations can ultimately correspond to a different text in the second writing system desired by the user 108. An example user input 400 in the Latin alphabet writing system for a user 108 attempting to obtain Cantonese text in Chinese characters is described with reference to FIG. 4 below.

Referring now to FIG. 4, an example user input 400 of “gongtungw” and its corresponding segmentations 410-1, 410-2 . . . 410-m (referred to herein individually and collectively as “segmentation 410” and “segmentations 410,” respectively) are shown. Each of the segmentations 410 include at least one segment; for example, the segmentation 410-1 corresponding to “gong-tung-w” has three segments: “gong,” “tung” and “w.” Each segment can include at least one character in the first writing system.

The fuzzy model 320 can be applied to one or more of the segmentations 410 to obtain at least one potential formal representation for each of the segmentations 410. Each potential formal representation can be in the first writing system and be representative of text in the second writing system. In the illustrated example of FIG. 4, the segmentation 410-1 is shown as corresponding to potential formal representations “gong-tung-waa” 420-1, “gwong-dung-wa” 420-2 and “gwong-dung-waa” 420-n (referred to herein individually and collectively as “potential formal representation 420” and “potential formal representations 420,” respectively). It should be appreciated that the illustrated potential formal representations are merely examples, and more or less potential formal representations can be obtained for each segmentation (including segmentation 410-1 corresponding to “gong-tung-w”).

The fuzzy model 320 can be a list of mappings between a set of tokens and a set of corresponding syllables of a formal representation standard. For example only, the set of tokens can represent all possible characters or grouping of characters identified in the formal representation standard. In some representation standards, the set of tokens includes all phonemes (e.g., vowels and consonants) in the writing system of the formal representation standard. Further, each of the syllables can include one or more tokens (phonemes). For example, in the Yale representation standard of Cantonese, a syllable can contain either (i) a vowel (aa, ong, ou, on, ung, etc.), or (ii) a consonant (d, g, gw, t, w, etc.) in combination with a vowel.

Rather than map all possible representations of syllables to a set of formal syllables, in some embodiments the fuzzy model 320 can instead map each possible token to a phoneme. For example only, in Cantonese a user input of “gong” can be mapped by the fuzzy model 320 to its corresponding set of formal syllables by combining the maps of: (i) the token “g” and its corresponding consonants “g” and “gw” and (ii) the token “ong” and its corresponding vowels “ong” and “ung.”

The fuzzy model 320 and its associated mappings can be generated in various ways. In some embodiments, the fuzzy model 320 can be trained based on one or more of: (i) machine learning techniques applied to training data, (ii) existing representation standards (Jyutping, Pinyin, Yale, etc.), and (iii) linguistic knowledge of the second writing system and its corresponding language and native speakers.

With respect to utilizing linguistic knowledge to train the fuzzy model 320, for certain languages and/or writing systems there may be “common” or not atypical misspellings or informal representations of character candidates that do not exist in any formal representation standard. These “fuzzy” tokens may be prevalent in the training data or a portion of the training data (e.g., in training data associated with a particular category of users, or users in a particular geographic area). For example only, a certain dialect or accent of a spoken language may result in a user that speaks that dialect or has that accent to repeatedly utilize an informal, “fuzzy” token to represent a specific syllable. Additionally, users that have a familiarity with a particular language (French, English, etc.) associated with the first writing system (the Latin alphabet writing system) may also repeatedly utilize an informal “fuzzy” token. The fuzzy model 320 can be trained to identify and map these “fuzzy” tokens to their associated symbols.

For an example syllable of “gong” in the Yale representation standard of Cantonese, the fuzzy model may associate the tokens “gong,” “gwong,” gung” and “gwung” with the syllable “gong” due to the mappings of “g” to “g” and “gw” and “ong” to “ong” and “ung” discussed above. There may be an additional mapping of the token “kong” to “gong” based on linguistic knowledge to account for this not atypical mapping.

In another example, the Yale representation standard maps the user input “geui” to, among potentially other character candidates, the character “ [symbol] ” in Cantonese. A user 108 with a degree of familiarity with the English language may provide an input substantially similar or identical to “geui.” A user 108 that is more familiar with the French language, however, may instead provide an input of “gueille” due to that user's 108 understanding of the pronunciation of the characters in the Latin alphabet writing system. The fuzzy model 320 can be robust to these types of variations such that these “fuzzy” tokens are mapped to their associated symbols.

In some embodiments, the fuzzy model 320 may be selected for use by the particular user 108. For example only, if the user 108 has some familiarity with a particular representation standard, that representation standard can be selected by the user 108, e.g., upon initialization of the IME Engine 300. Additionally or alternatively, a particular fuzzy model 320 may be automatically selected by the computing device 100, e.g., based on a geographic area associated with the user 108, and/or an indication of familiarity with a particular language (English, French, etc.).

Furthermore, once selected or generated, the fuzzy model 320 can be adapted to increase its utility and/or accuracy for users, in general, or a particular user 108. For example only, further linguistic knowledge can be gained and further mappings can be added to the fuzzy model 320. Additionally, the fuzzy model 320 can be adapted through use by users, in general, or the particular user 180, e.g., to identify repeated use of specific “fuzzy” tokens to represent a specific syllable. It should be appreciated that adapting the fuzzy model 320 may include adjustment of the probabilities associated with user input/potential formal representations/character candidates described below, in addition or as an alternative to the other adaptations described above.

The fuzzy model 320 may also associate and provide a probability for each specific potential formal representation 420 based on the user input 400. The probability can represent the likelihood that the specific potential formal representation 420 corresponds to the user input 400. The probability for each specific potential formal representation 420 based on the user input 400 can be determined in many ways. In some embodiments, the probability can be based on an occurrence probability derived from training data, and/or a probability derived in whole or in part based on use of the IME Engine 300 by the user 108.

The character candidate module 330 can determine a plurality of character candidates 430-1 . . . 430-p (referred to herein individually and collectively as “character candidate 430” and “character candidates 430,” respectively) based on the potential formal representations 420. Each of the character candidates 430 is written in the second writing system and can be a possible appropriate representation of the user input 400 in the second writing system. In the illustrated example, the character candidates “ [symbol] ” 430-1 and “ [symbol] ” 430-p represent possible appropriate representations of the user input “gongtungw” 400.

Each potential formal representation 420 can correspond to one, or many, character candidates 430. Further, each specific character candidate 430 can be associated with a probability that the specific character candidate 430 corresponds to its associated potential formal representation 420. For example, the specific character candidate “ [symbol] ” 430-1 can have an associated probability that represents the likelihood that it corresponds to the potential formal representation “gong-tung-waa” 420-1.

The computing device 100 can output the plurality of character candidates 430. For example only, the plurality of character candidates 430 can be displayed on a display (user interface 104) of the computing device. It should be appreciated that, in some embodiments, only a subset of all potential character candidates 430 may be displayed, depending upon the size of the user interface 104 and/or other factors. Furthermore, in some embodiments, each of the character candidates 430 is displayed along with its associated potential formal representation 420. In this manner, the user 108 can be presented with the potential formal representation 420, and its associated character candidate 430, corresponding to the user input 400.

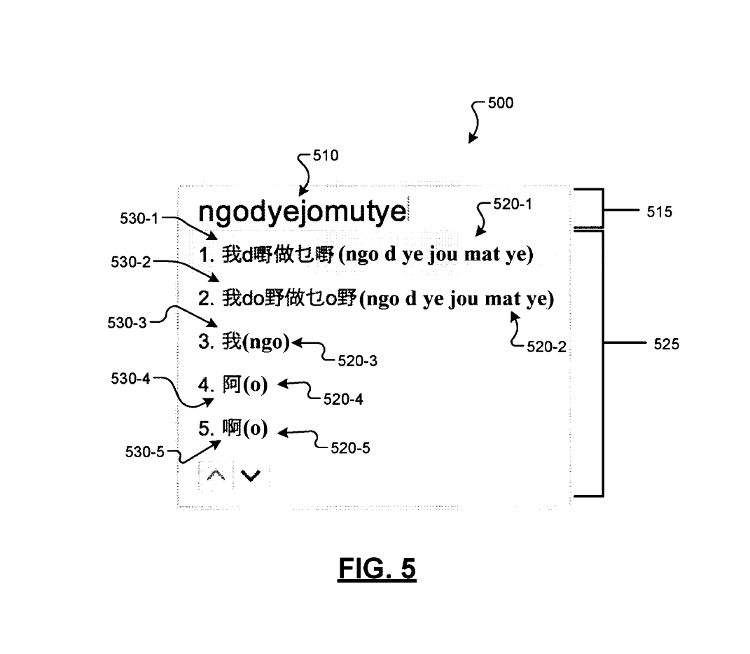

In various embodiments, the character candidates 430 can be displayed in a ranked order. The ranked order may correspond to presenting the character candidate 430 with the highest likelihood of representing the user input 400 in a first position, the character candidate 430 with the second highest likelihood of representing the user input 400 in a second position, and so on in descending order. In alternative embodiments, the ranked order may correspond to presenting character candidates 430 in descending order of likelihood, while also providing a diversity of potential character candidates 430 to the user 108 (described more fully below in reference to the example shown in FIG. 5).

The likelihood that each character candidate 430 represents the user input 400 can be determined in a number of different ways. In various embodiments, the likelihood for each particular character candidate 430 can be based on (i) a first probability that the particular potential formal representation 420 with which it is associated corresponds to the user input 400, and (ii) a second probability that the particular potential formal representation 420 corresponds to the particular character candidate 430. For example only, and with reference to FIG. 4, the likelihood that the character candidate “ [symbol] ” 430-1 corresponds to the user input “gongtungw” 400 can be based on (i) a first probability that the particular potential formal representation “gong-tung-waa” 420-1 corresponds to the user input “gongtungw” 400, and (ii) a second probability that the particular potential formal representation “gong-tung-waa” 420-1 corresponds to the particular character candidate “ [symbol] ” 430-1.

The likelihoods and probabilities described above can be derived from training data and/or through the use of the IME Engine 300 by the user 108. For example only, the computing device 100 may adapt the IME Engine 300 based on behavior of the user 108. Furthermore, the IME Engine 300 may be occasionally updated or adapted based on additional data or through use of the IME Engine 300, as described more fully herein.

Referring now to FIG. 5, an example display 500 on the user interface 104 of the computing device 100 according to some embodiments of the present disclosure is illustrated. A user input 510 (“ngodyejomutye”) has been entered by the user 108 and is displayed in a text entry area 515 of the display 500. The example user input “ngodyejomutye” 510 is associated with an attempt by the user 108 to input, in a Latin alphabet writing system, a formal representation of Cantonese text in a second writing system, Chinese characters.

A plurality of potential formal representations 520-1, 520-2 . . . 520-5 (collectively, “potential formal representations 520”) and associated character candidates 530-1, 530-2 . . . 530-5, respectively (collectively, “character candidates 530”), may be displayed in a candidate display area 525. As described above, the character candidates 530 can be presented in a ranked order in which the most probable character candidate 530-1 is presented in a first position (“1”), with the remaining character candidates 530 being displayed in a descending order of probability.

The example display 500 further illustrates two special cases associated with the Cantonese language and its associated formal Romanization standards. Cantonese speakers may be familiar with representing “mouth radicals” in an “oX” version to a computing device. For example only, the mouth radical “ [symbol] ” may instead be represented by “o [symbol] ” on a display of a computing device, e.g., depending on the preference of the user 108. Another example of this type of “oX” representation is shown in FIG. 5, in which character candidate 530-1 includes the formal mouth radicals and character candidate 530-2 includes the “oX” version of the mouth radicals.

FIG. 5 also illustrates the special case of “di” in the character candidates 530-1 and 530-2. Similar to the use of “oX” versions of characters, a user 108 may prefer to utilize the Latin alphabet character “d” instead of the more traditional characters “ [symbol] ” (formal mouth radical) or “o [symbol] ” (“oX” version). It should be appreciated that, while the illustrated example is directed to special cases in a formal Romanization standard of Cantonese, the IME Engine 300 can be configured to provide for special cases in other writing systems and languages. For example only, some users may substitute the Arabic “Yeh” character (“ [symbol] ”) for the Persian representation of the “Yeh” character (“ [symbol] ”). Thus, it may be desirable to present the Arabic character candidate “ [symbol] ” an option to a user 108 that has input “Yeh” to a Persian IME.

In order to provide a diversity of options to the user 108, the display 500 may include one or more character candidates 530 corresponding to the entire user input “ngodyejomutye” 510 (character candidates 530-1 and 530-2), as well as one or more character candidates 530 corresponding to only a portion (e.g., the first or beginning portion) of the user input “ngodyejomutye” 510 (character candidates 530-3, 530-4 and 530-5). The selection of one of the character candidates 530-1 and 530-2 corresponding to the entire user input 510 can operate to replace the user input 510 with the selected character candidate 530-1, 530-2 in the text entry area 515. In contrast, the selection of one of the character candidates 530-3, 530-4 and 530-5 corresponding to only a portion of the user input 510 can operate to replace that portion of the user input 510 in the text entry area 515. The remainder of the user input 510 can then be interpreted by the IME Engine 300 to obtain a plurality of character candidates for that remainder. In this manner, the user 108 can quickly and efficiently enter the desired text in the second writing system.

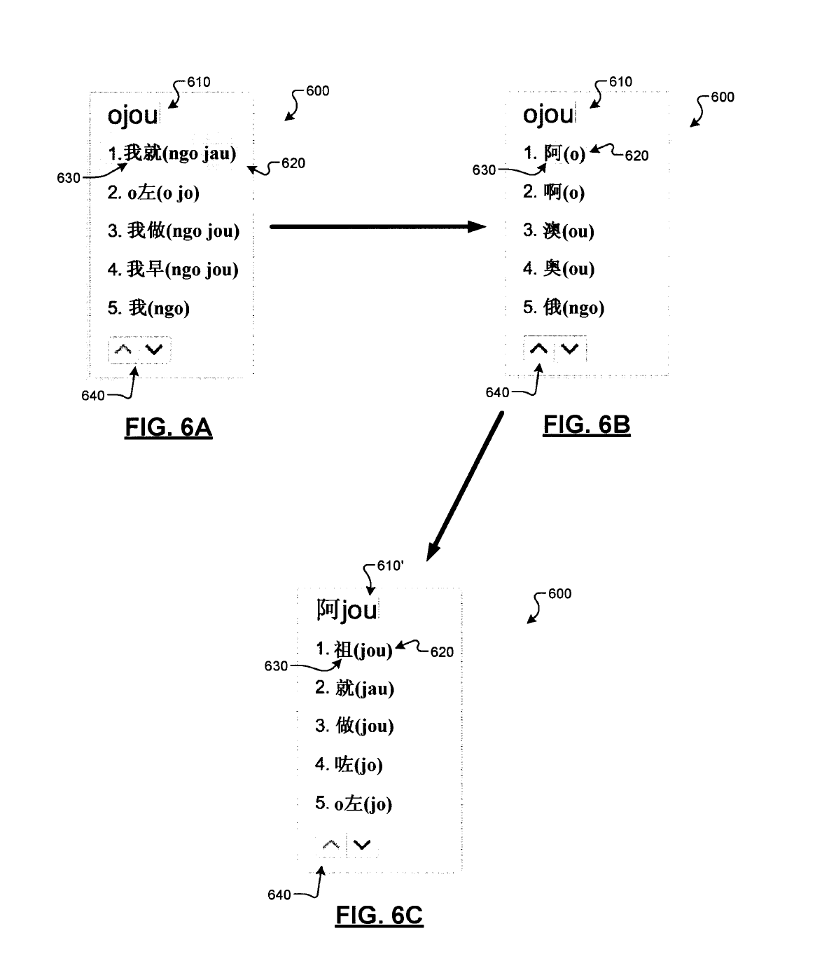

Referring now to FIGS. 6A-6C, an example display 600 on the user interface 104 of the computing device 100 according to some embodiments of the present disclosure is illustrated. In the illustrated example, the user 108 has provided a user input 610 corresponding to “ojou” in a Latin alphabet writing system to obtain a plurality of Chinese character candidates for Cantonese. Similar to FIG. 5 described above, a plurality of character candidates 630 are displayed with their associated potential formal representations 620.

As shown in FIG. 6A, five character candidates 630 and their associated potential formal representations 620 are output to the display 600. Additionally, one or more arrow buttons 640 can be provided on the display. The arrow buttons 640 allow the user 180 to switch the list of character candidates 630 to display more options. Upon actuation of the “down” arrow button 640 in the display of FIG. 6A, the display 600 of FIG. 6B can be displayed, which provides additional character candidates 630 and potential formal representations 620 different from those of FIG. 6A.

In the illustrated example, the user 180 has selected option “1” of FIG. 6B, e.g., by touching this selection on the touch display or actuating the number “1” when the display 600 of FIG. 6B is being displayed. This selection will then replace that portion (“o”) of the user input 610 corresponding to the selected option, resulting in the display 600 of FIG. 6C and modified user input 610′. Modified user input 610′ can then be provided to the IME Engine 300, which will provide additional character candidates 630 based on the modified user input 610′ as shown in FIG. 6C.

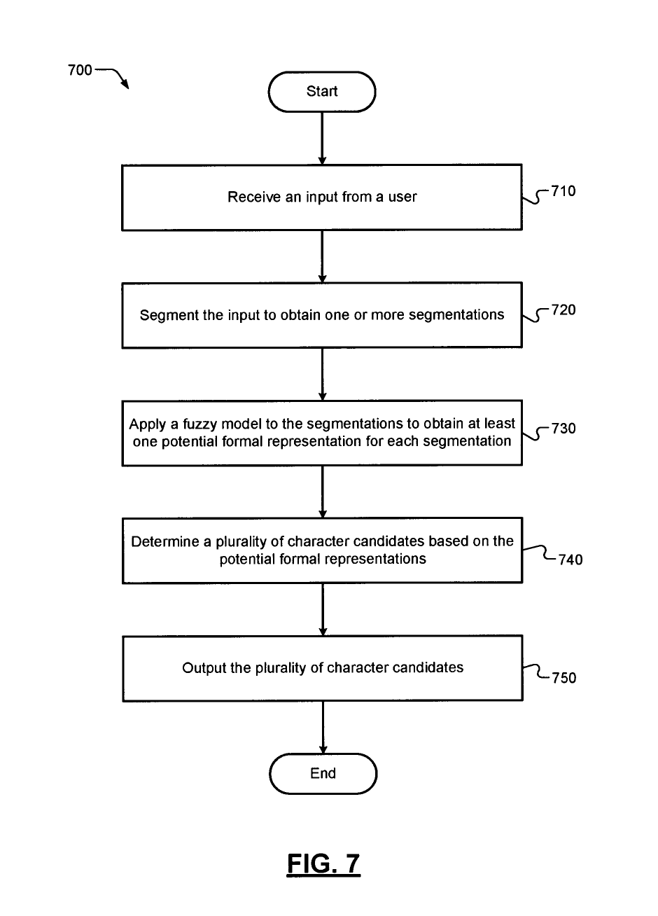

Referring now to FIG. 7, a flowchart describing an example method 700 according to some embodiments of the present disclosure is illustrated. The method 700 can be performed by the example computing device 100 described above, either alone or in conjunction with one or more other computing devices (such as, the server computing device 260).

At 710, an input from a user 108 is received. The input can comprise one or more characters in a first writing system. For example only, the first writing system can be a Latin alphabet based writing system such as that described above. The input can be segmented at 720 to obtain one or more segmentations. Each of the segmentations can include at least one segment, and each segment can include at least one character in the first writing system.

At 730, a fuzzy model can be applied to the segmentations to obtain at least one potential formal representation for each of the segmentations. The potential formal representations can be in the first writing system and be representative of text in a second writing system, e.g., Chinese characters representing Cantonese as described above. The potential formal representations can correspond to one or more representation standards associated with the first and second writing systems.

Based on the potential formal representations, a plurality of character candidates can be determined at 740. Each of the character candidates can be in the second writing system. Further, each of the character candidates can be a possible appropriate representation of the user input in the second writing system. For example, the character candidates can include the most likely representation of the user input in the second writing system. As described above, these character candidates can be obtained by operation of the IME Engine 300. At 750, the plurality of character candidates can be output, e.g., by displaying a set of character candidates on a display of the computing device 100.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device including one or more processors, an input from a user, the input comprising one or more characters in a first writing system;
segmenting, at the computing device, the input to obtain one or more segmentations, each segmentation comprising at least one segment, wherein each segment includes at least one character in the first writing system;
applying, at the computing device, a fuzzy model to the one or more segmentations to obtain at least one potential formal representation for each of the segmentations, each potential formal representation being in the first writing system and representing text in a second writing system;
determining, at the computing device, a plurality of character candidates based on the potential formal representations, each of the plurality of character candidates being in the second writing system and being a possible appropriate representation of the user input in the second writing system; and
outputting, at the computing device, the plurality of character candidates.

2. The method of claim 1, wherein the applying the fuzzy model to the one or more segmentations includes obtaining a probability for each specific potential formal representation, the probability representing a likelihood that the specific potential formal representation corresponds to the input.

3. The method of claim 1, wherein outputting the plurality of character candidates comprises displaying a set of the plurality of character candidates in a ranked order on a display of the computing device, the ranked order being based on a likelihood that each character candidate of the set of the plurality of character candidates corresponds to the input.

4. The method of claim 3, wherein each particular character candidate of the set of the plurality of character candidates is associated with a particular potential formal representation, and the likelihood for each particular character candidate is based on: (i) a first probability that the particular potential formal representation corresponds to the input, and (ii) a second probability that the particular potential formal representation corresponds to the particular character candidate.

5. The method of claim 4, further comprising receiving a user selection of one of the set of the plurality of character candidates, and displaying on the display the selected one in a text entry area.

6. The method of claim 4, wherein displaying the set of the plurality of character candidates on the display of the computing device further comprises displaying each particular character candidate with its associated particular potential formal representation.

7. The method of claim 1, wherein each particular character candidate of the plurality of character candidates is associated with a particular potential formal representation, and wherein outputting the plurality of character candidates comprises displaying, on a display of the computing device, at least one specific character candidate of the plurality of character candidates and its associated potential formal representation.

8. The method of claim 1, wherein:
the first writing system is a Latin alphabet writing system,
the second writing system is a non-Latin alphabet writing system, and
the formal representation is a formal Romanization.

9. The method of claim 1, wherein the second writing system is written Cantonese.

10. The method of claim 9, wherein each potential formal representation is a Yale representation.

11. A computing device, comprising:
a display;
one or more processors coupled to the display; and
a non-transitory computer-readable storage medium storing executable computer program code, the one or more processors configured to execute the executable computer program code to perform operations including:
receiving an input from a user, the input comprising one or more characters in a first writing system;
segmenting the input to obtain one or more segmentations, each segmentation comprising at least one segment, wherein each segment includes at least one character in the first writing system;
applying a fuzzy model to the one or more segmentations to obtain at least one potential formal representation for each of the segmentations, each potential formal representation being in the first writing system and representing text in a second writing system;
determining a plurality of character candidates based on the potential formal representations, each of the plurality of character candidates being in the second writing system and being a possible appropriate representation of the user input in the second writing system; and
outputting the plurality of character candidates.

12. The computing device of claim 11, wherein the applying the fuzzy model to the one or more segmentations includes obtaining a probability for each specific potential formal representation, the probability representing a likelihood that the specific potential formal representation corresponds to the input.

13. The computing device of claim 11, wherein outputting the plurality of character candidates comprises displaying a set of the plurality of character candidates in a ranked order on the display, the ranked order being based on a likelihood that each character candidate of the set of the plurality of character candidates corresponds to the input.

14. The computing device of claim 13, wherein each particular character candidate of the set of the plurality of character candidates is associated with a particular potential formal representation, and the likelihood for each particular character candidate is based on: (i) a first probability that the particular potential formal representation corresponds to the input, and (ii) a second probability that the particular potential formal representation corresponds to the particular character candidate.

15. The computing device of claim 14, wherein the operations further include receiving a user selection of one of the set of the plurality of character candidates, and displaying on the display the selected one in a text entry area.

16. The computing device of claim 14, wherein displaying the set of the plurality of character candidates on the display of the computing device further comprises displaying each particular character candidate with its associated particular potential formal representation.

17. The computing device of claim 11, wherein each particular character candidate of the plurality of character candidates is associated with a particular potential formal representation, and wherein outputting the plurality of character candidates comprises displaying, on the display, at least one specific character candidate of the plurality of character candidates and its associated potential formal representation.

18. The computing device of claim 11, wherein:
the first writing system is a Latin alphabet writing system,
the second writing system is a non-Latin alphabet writing system, and
the formal representation is a formal Romanization.

19. The computing device of claim 11, wherein the second writing system is written Cantonese.

20. The computing device of claim 19, wherein each potential formal representation is a Yale representation.

21. A non-transitory computer-readable storage medium storing computer executable code that, when executed by a computing device having one or more processors, cause the computing device to perform operations comprising:
receiving an input from a user, the input comprising one or more characters in a first writing system;
segmenting the input to obtain one or more segmentations, each segmentation comprising at least one segment, wherein each segment includes at least one character in the first writing system;
applying a fuzzy model to the one or more segmentations to obtain at least one potential formal representation for each of the segmentations, each potential formal representation being in the first writing system and representing text in a second writing system;
determining a plurality of character candidates based on the potential formal representations, each of the plurality of character candidates being in the second writing system and being a possible appropriate representation of the user input in the second writing system; and
outputting the plurality of character candidates.

22. The non-transitory computer-readable storage medium of claim 21, wherein each particular character candidate of the plurality of character candidates is associated with a particular potential formal representation, and wherein outputting the plurality of character candidates comprises displaying, on the display, at least one specific character candidate of the plurality of character candidates and its associated potential formal representation.
